(19) United States
(12) Patent Application Publication
(10) Pub. No.: US 2009/0139139 A1
(43) Pub. Date: Jun. 4, 2009

(54) COMPOSITIONS AND METHODS FOR SEQUESTERING CARBON

(76) Inventors: G. David Tilman, St. Louis Park, MN (US); Dario Fornara, Cureggio (IT); Jason Hill, Northfield, MN (US); Clarence Lehman, Maplewood, MN (US)

Correspondence Address: FISH & RICHARDSON P.C., PO BOX 1022, MINNEAPOLIS, MN, 55440-1022, US

(21) Appl. No.: 12/328,360

(22) Filed: Dec. 4, 2008

Related U.S. Application Data
(60) Provisional application No. 60/992,203, filed on Dec. 4, 2007.

(51) Int. Cl. A01G 1/00

(52) U.S. Cl. 47/58.1 R

(57) ABSTRACT

Provided herein are mixtures of C4 grasses and legumes, and methods of using such mixtures to sequester carbon. Methods of using the sequestered carbon in the form of, for example, carbon credits, to offset or mitigate carbon usage also are provided.

### CROSS REFERENCE TO RELATED APPLICATIONS

This application claims priority under 35 U.S.C. § 119(e) of U.S. provisional application Ser. No. 60/992,203, filed Dec. 4, 2007.

### FEDERALLY SPONSORED RESEARCH OR DEVELOPMENT

The U.S. Government has certain rights in this invention pursuant to Grant Nos. DEB 0080382 and DEB 0620652 awarded by the National Science Foundation.

### TECHNICAL FIELD

This invention relates to mixtures of C4 grasses and legumes, and more particularly to methods of using such mixtures of C4 grasses and legumes to sequester carbon.

### BACKGROUND

Capturing and storing carbon in biomass and soils in the agriculture and forest sector has gained widespread acceptance as a potential greenhouse gas mitigation strategy. It is known that various land-use practices such as the introduction of cover crops on fallow land, the conversion of conventional tillage to conservation tillage, and the retirement of land from active production to a grass cover or trees can be used to sequester carbon. Carbon sequestration is the annual average of the total accumulated carbon (e.g., the difference of the total soil carbon pool at the beginning and the end of a simulation period).

### SUMMARY

Provided herein are mixtures of at least one C4 grass and at least one legume and methods of using such mixtures. Since the use of such mixtures results in a significant amount of carbon sequestered, also provided are methods of converting such sequestered carbon to a tradable or marketable unit (e.g., carbon credits) to offset or mitigate carbon usage and emissions.

In one aspect, the invention provides for methods of monitoring a field that consists essentially of a mixture of at least one C4 grass and at least one legume. Such methods generally include monitoring the field for carbon levels in the soil and/or carbon levels in the root biomass. Typically, a field is monitored for nitrogen levels in the soil, below-ground biomass, above-ground biomass, and/or the number of legumes relative to the total number of legumes and C4 grasses in the field.

In another aspect, the invention provides for methods of maintaining a field that consists essentially of a mixture of at least one C4 grass and at least one legume. Such methods generally include monitoring the field for carbon levels in the soil and/or carbon levels in the root biomass; and adjusting the number of C4 grasses and/or legumes, if necessary. In one embodiment, the number of C4 grasses and/or legumes is adjusted if the carbon levels in the soil and/or the root biomass fail to increase at the desired rate. In another embodiment, the number of C4 grasses and/or legumes is adjusted if the nitrogen levels in the soil decrease or fail to increase at the desired rate, if the amount of biomass decreases, and/or if the number of legumes decreases to less than 5% (w/w) or increases to more than 50% (w/w) of the total biomass of legumes and C4 grasses in the field.

In still another aspect, the invention provides for methods of applying for one or more carbon credits. Such methods typically include growing, in a field, for at least two years, a mixture consisting essentially of at least one C4 grass and at least one legume; obtaining certification for a reduction of CO₂ emissions and/or for an amount of carbon sequestered in plant biomass and/or in soil; and applying for one or more carbon credits based on the certification obtained. Such methods also can include harvesting the above-ground biomass such as from the C4 grasses; adjusting the number of legumes relative to the total number and/or biomass of legumes and C4 grasses in the field; and/or measuring the amount of carbon in the soil or in the plant biomass.

In yet another aspect, the invention provides for methods of offsetting the carbon footprint of a fuel- or power-producing company or a fuel- or power-using company. Such methods typically include identifying a fuel- or power-producing or -using company in need of carbon offsetting; planting sufficient acreage with a mixture consisting essentially of about 20% to about 80% C4 grasses and about 20% to about 80% legumes, wherein said acreage is sufficient to offset, at least partially, the carbon footprint of said fuel- or power-producing or -using company.

In one embodiment, the fuel- or power-producing company produces ethanol or another biofuel, or electricity. In another embodiment, the above-ground biomass from said field is harvested to supply biofuel feedstock or to provide power to the fuel- or power-producing or -using company. In such cases, said acreage typically is within 60 miles of the fuel-producing or -using company. In certain instances, said acreage is monitored for carbon levels in the soil and/or carbon levels in the root biomass. Such methods also can include applying for carbon credits.

In one aspect, the invention provides for methods of sequestering carbon. Such methods generally include growing, for at least two years, a mixture consisting essentially of about 20% to about 80% (w/w) of at least one C4 grass and about 20% to about 80% (w/w) of at least one legume in a field. Typically, is sequestered in the root biomass and/or in the soil. Such methods also can include obtaining certification for one or more carbon credits based on the carbon sequestered.

In another aspect, the invention provides for methods of producing biomass. Such methods typically include growing, for at least three years, a mixture comprising about 20% to about 80% (w/w) of at least one C4 grasses and about 20% to about 80% (w/w) of at least one legume in a field to generate biomass. In certain instances, the biomass can be used as biofuel or to make biofuel.

In still another aspect, the invention provides for methods of restoring carbon to degraded or abandoned land. Such methods typically include identifying degraded or abandoned land in need of carbon restoration; planting a mixture comprising about 20% to about 80% (w/w) of at least one C4 grass and about 20% to about 80% (w/w) of at least one legume on said land and growing the mixture for at least two years. Such methods also can include adjusting the number of legumes if the number of legumes decreases to less than 5% of the total number of legumes and C4 grasses in the field and/or testing the soil for carbon levels before planting, during planting, and/or after harvesting. In one embodiment, said degraded or abandoned land is farm land.

In still another aspect, the invention provides for compositions that comprise (or consist essentially of) about 20% to about 80% (w/w) of seeds that mature into one or more C4 grasses; and about 20% to about 80% (w/w) of seeds that mature into one or more legumes. In certain embodiments, the composition essentially lacks seeds that mature into one or more C3 grasses.

In one aspect, the invention provides for fields seeded with about 20% to about 80% (w/w) of at least one C4 grass and about 20% to about 80% (w/w) of at least one legume, wherein said C4 grasses and said legumes are each distributed essentially uniformly in the field.

In another aspect, the invention provides for methods of establishing rates of carbon sequestration with a geographical area planted with a mixture consisting essentially of at least one C4 grass and at least one legume. Such methods generally include measuring an amount of carbon in soil at a first time point, measuring the amount of carbon in soil at a second time point, and calculating the rate of carbon sequestration.

In yet another aspect, the invention provides for methods of sequestering carbon in high-diversity mixtures of mainly perennial herbaceous plants in which the total mass of seed of C4 grasses and legumes is about 40% or more of the total seed planted. Generally, the C4 grasses make up about 30% to 70% of the total seed (w/w) of the planted C4 grasses and legumes and legumes make up the remainder.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In addition, the materials, methods, and examples are illustrative only and not intended to be limiting. All publications, patent applications, patents, and other references mentioned herein are incorporated by reference in their entirety. In case of conflict, the present specification, including definitions, will control.

The details of one or more embodiments of the invention are set forth in the accompanying drawings and the description below. Other features, objects, and advantages of the invention will be apparent from the drawings and detailed description, and from the claims.

### DESCRIPTION OF DRAWINGS

FIG. 1 are graphs showing the dependence of net soil carbon (a) and nitrogen (b) sequestration (as measured between 0-100 cm soil depth) on the number of plant species. Curves shown result from a simple asymptotic function fitted to treatment means. Regressions have df=1,152. Dashed lines represent 95% confidence bands.

FIG. 2 are graphs showing the dependence of net soil carbon (a) and nitrogen (b) sequestration (at different soil depth increments) on the number of plant species (regression model has df=7,608). Standard error bars indicate variability within each soil depth increment.

FIG. 3 are graphs showing the dependence of total below-ground plant biomass as measured in the fall (a) and net root production measured over two months in the fall (b) on the number of plant species. Curves shown result from a simple asymptotic function fitted to treatment means. Regressions have df=1,152 and df=1,60. Dashed lines represent 95% confidence bands.

FIG. 4 are graphs showing the dependence of net soil carbon (a) and nitrogen (b) sequestration (between 0-100 cm soil depth) on total below-ground biomass as measured in the fall. Regressions have df=1,152. Dashed lines represent 95% confidence bands.

FIG. 5 are graphs showing the dependence of total root biomass accumulation (as measured in the fall at different soil depth levels) on the presence or absence of C4 grasses and legumes (a; asterisks indicate P<0.001) and dependence of total root biomass and root carbon:nitrogen ratio on plant functional composition (b): monoculture plots (C3=C3 grasses, C4=C4 grasses, L=legumes and F=forbs); plots with at least one C4 grass and one legume species planted within the 2, 4 and 8-species diversity plots=C4L; other plant functional combinations within the 2, 4 and 8-species plots=Other, and high-diversity plots (HD=16-species plots).

FIG. 6 are graphs that show the complementarity between C4 grasses and legumes in root biomass (panel A) and the resulting effect on carbon sequestration (panel B).

Like reference symbols in the various drawings indicate like elements.

### DETAILED DESCRIPTION

Described herein are mixtures of at least one C4 grass and at least one legume, and methods of using such mixtures. When grown together in a field, mixtures of at least one C4 grass and at least one legume exhibit complementarity, which results in a significant amount of carbon that is sequestered in both the soil and in the below-ground biomass. If the above-ground biomass is ultimately used as a biofuel, the compositions and methods described herein can result in net negative CO₂ emissions across the entire lifecycle of the fuel. In addition, fields grown with mixtures of at least one C4 grass and at least one legume require very low net energy inputs (e.g., weeding, cultivating, or application of fertilizer and/or pesticide), which ultimately results in a biofuel that contains much more useful energy than the fossil energy used in the production of the biofuel. Also described herein are methods of converting such net energy gain into tradable or marketable units such as carbon credits.

### Plant Species

C4 plants capture CO₂ at night when the air is cooler and photosynthesize the CO₂ during the day when light is available. Any C4 grass from the Poaceae or Gramineae family can be used as described herein, and representative C4 grasses include, without limitation, Andropogon gerardi, Schizachyrium scoparium, Sorghastrum nutans, Panicum vargatum, Bouteloua curtipendula, Bouteloua gracilis, Sporobolus cryptandrus, and Buchloe dactyloides. C3 plants, on the other hand, necessarily capture and photosynthesize CO₂ during the day. C4 metabolism consumes slightly more energy than does C3 metabolism, but C4 plants capture and utilize more CO₂ than do C3 plants.

Legumes are members of the Fabaceae or Leguminosae family. Legumes have the ability, in the presence of Rhizobia, to fix atmospheric nitrogen. This ability reduces fertilizer costs for growing legumes and has been used to replenish soil that has been depleted of nitrogen. There are about 730 genera and over 19,400 species of legumes, with the largest genera including Astragalus, Acacia, Indigofera, Crotalaria, and Mimosa. Representative legumes that can be used in the mixtures described herein include Lupinis perennis, Amorpha canescens, Lespedeza capitata and Petalostemum purpureum. Those in the art are aware that legumes include perennial legumes as well as semi-perennial and annual legumes. One or more of the legumes in the mixtures described herein can be an annual legume or a semi-perennial legume. It would be understood by those of skill, however, that the use of semi-perennial or annual legumes requires re-planting every year or every few years in order to maintain the complementarity effect between the C4 grasses and the legumes and, therefore, an optimal amount of biomass production and carbon sequestration.

It is reported herein that growing low-diversity mixtures consisting essentially of at least one C4 grass and at least one legume results in significantly increased root biomass and carbon sequestration compared to monocultures (e.g., monocultures of either C4 grasses or legumes). A simple increase in plant biomass is not sufficient to account for the increase in carbon sequestration as high diversity fields having greater biomass sequestered less carbon than did low diversity fields having the same or less biomass. As used herein, fields planted with a mixture “consisting essentially of” one or more C4 grass and one or more legumes means that the total number of C4 grass and legume species planted constitutes at least 40% of the total number of perennial herbaceous plants in the field (e.g., at least 45%, 50%, 55%, 60%, 65%, 70%, 75%, 80%, 85%, 90%, 95%, 99%, 100% or any number between 40% and 100%). It is understood by those of skill in the art that species other than C4 grasses and legumes may be present in a field provided that those other species do not substantially decrease the amount of carbon sequestered by the mixture of at least one C4 grass and at least one legume. A “substantial decrease” in the amount of carbon sequestered is considered to be a reduction of 10% or more in the amount of carbon sequestered.

According to the present disclosure, additional species diversity that would decrease the planted seed mass of legumes and C4 grasses or the number of planted legumes and C4 grasses growing in the field to below 40% of the total seed mass or total number of perennial herbaceous plants generally is undesirable since non-C4 grasses and non-legumes do not augment the beneficial effects described herein but still consume resources. For example, plants that can be found growing in combination with C4 grasses are C3 grasses and forbs. Neither C3 grasses nor forbs, however, significantly contribute to the carbon-negative effects that are observed with a mixture of at least one C4 grass and at least one legume and, in some cases, may actually decrease the complementary effect observed between C4 grasses and legumes. Therefore, in some embodiments, the mixtures of C4 grasses and legumes described herein lack substantial numbers of C3 grasses and forbs. As used herein, “lacking a substantial number” of non-C4 grass/non-legume species (e.g., C3 grasses or forbs) means that each non-C4 grass species and non-legume species is present in the field at no more than 10% of the total plant biomass or total number of plants in the field (e.g., no more than 8%, 6%, 5%, 4%, 3%, 2% or 1%).

Given the complementarity between C4 grasses and legumes, mixtures of at least one C4 grass and at least one legume can be packaged and provided, for example, in bags of seeds to farmers or other agricultural operators for planting. Bags and other types of containers for packaging seeds have been known in the art for well over a century. See, for example, yankeegardener.com/seeds.html, planetpatchwork.com/feedsack.htm, ohioline.osu.edu/cd-fact/0133.html, and curryseed.com/history on the World Wide Web for disclosure regarding the history of seed packaging in tins, boxes, wooden barrels, and cloth bags.

Mixtures of at least one C4 grass and at least one legume as described herein generally include about 20% (w/w) to about 80% (w/w) of seeds that mature into one or more C4 grasses (e.g., about 30% (w/w) to about 70% (w/w); about 40% (w/w) to about 60% (w/w); about 50% (w/w) to about 70% (w/w); or about 65% (w/w)) and about 20% (w/w) to about 80% (w/w) of seeds that mature into one or more legumes (e.g., about 30% (w/w) to about 70% (w/w); about 40% (w/w) to about 60% (w/w); about 35% to about 55%; or about 35% (w/w)). As used herein, the percentage of plants, e.g., C4 grasses or legumes, in a field is relative to the total number of plants in a field. For example, to determine the percentage of C4 grasses in a field, one determines or estimates the total number of C4 grass plants in the field (e.g., the combined number of, e.g., Andropogon gerardi and Panicum vargatum plants) and divides that number by the total number of C4 grass plants and legume plants in the field. A person of ordinary skill in the art will appreciate that a plant is not defined solely by the presence of above-ground vegetative biomass, as the presence of above-ground vegetative biomass for C4 grasses and for legumes changes depending upon the time of year.

For optimal carbon sequestration, C4 grasses and legumes should be distributed essentially uniformly in the field. It is understood by those of skill in the art that the number of C4 grasses and the number of legumes in a field will equilibrate over a period of years to a proportion that is appropriate to the relevant conditions. Therefore, the number of legumes relative to C4 grasses can be adjusted (e.g., replanted) to continue to achieve optimal carbon sequestration. For example, under certain circumstances, either or both the C4 grasses and legumes may need to be replanted if, for example, one or more of the species establish poorly or are damaged due to acts of nature (e.g., hail or flood). In addition, one or more legumes can be added to fields that already contain C4 grasses (e.g., conservation reserve program (CRP) lands). For optimal carbon sequestration, it may be necessary to remove non-C4 grasses and non-legumes from the field so that, once legumes are introduced, the field consists essentially of C4 grasses and legumes.

The combinations of C4 grasses and legumes described herein can be grown continuously for a number of years with or without harvesting or burning off the above-ground biomass. Harvesting or burning is not necessary to achieve significant amounts of carbon sequestration and, in many cases, is not desired as it requires some amount of energy input. The plant biomass, however, can be harvested and used, for example, as feedstocks for biofuel or for combustion. For example, the biomass can be combusted to generate electricity, co-combusted with coal to generate electricity, used to produce ethanol (i.e., cellulosic ethanol), or used in gasification to make synthetic fuels (syngas).

### Carbon Sequestration and Carbon-Negative Activities

The mixtures of C4 grasses and legumes described herein were found to sequester a significant amount of carbon in both the plant biomass as well as in the soil. The amount of carbon sequestered in soil and/or plant biomass can be measured using any number of methods routine in the art. See, for example, Lal, 2001, Assessment Methods for Soil Carbon, CRC Press. For example, in addition to directly measuring the organic carbon in the soil and/or plant material, indirect methods such as dichromate oxidation, loss-on-ignition (LOI), or diffuse reflectance infrared spectroscopy can be used to measure the amount of carbon. When measuring soil carbon, it is desirable to obtain samples from the upper meter of soil.

It will be understood by those of skill in the art that carbon sequestration initially may be detectable in the plant biomass and possibly may not be detectable in the soil during the first several years of growth. However, it will also be appreciated by those of skill in the art that carbon begins accumulating in the soil soon after the plants sprout and begin photosynthesizing, even if a detectable difference is not observed over the first few years. In addition, the carbon sequestration likely will continue indefinitely as long as a mixture consisting essentially of at least one C4 grass and at least one legume is maintained in the field.

The amount of carbon sequestered in the plant biomass and/or the soil can be monitored every year, every other year, every five years, or any other suitable time frame. Other features of the field can be monitored such as, for example, nitrogen levels in the soil, the amount of biomass (either or both C4 grasses and legumes), and the number of C4 grass plants and/or legume plants. Based upon the results of monitoring one or more features of the field, the number of C4 grasses and/or legumes in the field can be adjusted. For example, the number of legumes can be increased (e.g., by additional planting) if, for example, the carbon levels in the soil decrease, the nitrogen levels in the soil decrease, the amount of biomass decreases, or the number of legumes decreases to less than 5% of the total number of C4 grasses and legumes in the field. In certain instances, it may be desirable to cull plants if, for example, the number of legumes increases to more than 50% of the total number of C4 grasses and legumes in the field.

The compositions described herein that include mixtures of C4 grasses and legumes can be used to replenish and/or restore carbon to degraded and/or abandoned land. Degraded and/or abandoned land includes, for example, land that has been disturbed by mining, construction, or poor agronomic practices. Degraded and/or abandoned land includes land that has low agricultural value (e.g., land that has been over-farmed or over-cultivated). As indicated herein, carbon sequestration begins immediately, but for replenishment or restoration of degraded or abandoned land, the combination of C4 grasses and legumes can be grown for 5, 10, 15, 20, 25, 50, 60, or 100 years. In order to monitor the rate that carbon is restored or replenished to the land, the levels of carbon in the soil can be measured prior to planting the combination of C4 grasses and legumes, and can be monitored at any time during growth of the plants in the field. If necessary, the number of C4 grasses and/or legumes can be adjusted (e.g., by additional planting) to continue to replenish or restore significant amounts of carbon to the land.

The carbon that is sequestered in soil or in plant biomass as well as the overall carbon-negative effects produced by growing the mixtures described herein can be converted into, for example, an environmental credit such as a carbon credit. Carbon credits are used to provide an incentive to reduce greenhouse gas emissions by capping total annual emissions and letting the market assign a monetary value to a tradable unit. As used herein, carbon credits include carbon credits as defined by provisions in place at the time of filing but are not limited to such. Carbon credits also refer to any type of tangible or intangible currency, stocks, bonds, notes or other tradable or marketable unit used to value an amount of carbon sequestered, an amount of greenhouse gas emissions reduced, or any other type of carbon-neutral or carbon-negative activities. A similar concept of environmental credits can be applied, for example, for the implementation of best practices related to environmental land practices.

Trading or exchange systems in practice at the time of filing provide Exchange Soil Offsets (ESOs or XSOs), which are a type of carbon credit used to value carbon sequestered in soil. Fields planted with a mixture of at least one C4 grass and at least one legume as disclosed herein can provide another significant source of carbon credits in addition to the conventional sources typically referred to as allowances (defined under the European Trading Scheme (ETS) as one metric tonne of CO₂ emissions), which are distributed by an administrator, and certified emissions reductions (CERs), a credit obtained under current systems for reducing emissions in developing countries.

Carbon credits can be obtained, for example, by applying and receiving certification for the amount of carbon emissions reduced (e.g., the amount of carbon sequestered, the amount of CO₂ and other greenhouse gases not released into the atmosphere). The quality of the credits can be based in part on validation processes and the sophistication of funds or development companies that act as sponsors to carbon projects. See, for example, U.S. Patent Publication Nos. 2002/0173979 and 2007/0073604 for representative methods for verifying and valuing carbon credits. Carbon credits can be exchanged between businesses or bought and sold in national or international markets at a prevailing market price. In addition, companies can sell carbon credits to commercial and individual customers who are interested in voluntarily offsetting their carbon footprints. These companies may, for example, purchase the credits from an investment fund or a carbon development company that has aggregated the credits from individual projects.

The process of applying for, obtaining and/or validating one or more carbon credits may or may not include taking actual measurements. For example, in some instances, standards may be developed based upon certain characteristics such as field size, plant biomass, and number of C4 grasses and legumes in the field that can be used in the validation process. Simply by way of example, each transfer of carbon credits within Europe is validated by the ETS, and each international transfer is validated by the United Nations Framework Convention on Climate Change (UNFCCC).

A carbon footprint is the amount of carbon emitted by an entity (e.g., an individual or a company) from energy usage. There are a number of carbon calculators available that can be used to determine a company's or an individual's carbon footprint by inputting various aspects of energy consumption. Carbon offsetting refers to the process of compensating or mitigating one's carbon footprint and can be used in conjunction with carbon credits (and/or in conjunction with carbon taxes). Carbon offsetting enables individuals and company's to reduce the net CO₂ emissions for which they are responsible by offsetting, reducing or displacing the CO₂. Carbon-neutrality can be achieved by sufficiently offsetting carbon emissions.

It is envisioned that the benefits provided by growing a mixture of one or more C4 grasses and one or more legumes can be used in a variety of models such as those involved in the reduction of greenhouse gases and the ability to trade that value (e.g., in the form of carbon credits) on a market. For example, it is envisioned that individual farmers could grow and maintain fields having one or more C4 grasses and one or more legumes and convert the carbon sequestered and possibly other environmental best practices into carbon credits or a similar type of carbon-based and/or energy-based unit of value. Those individual farmers then could use those carbon credits to offset their own carbon footprints, or they could trade or sell those carbon credits on the market. In some embodiments, individual farmers may belong to a cooperative of farmers that could aggregate, sell and/or trade carbon credits. It is also envisioned that a company (e.g., a fuel- or power-producing company) may wish to plant and maintain, or have planted and maintained, fields containing one or more C4 grasses and one or more legumes. The carbon credits obtained from such fields can be used by the company to offset or mitigate the company's carbon footprint and, if carbon neutrality is reached, the remaining carbon credits can be sold or traded.

To further increase the carbon-negative effects of growing the mixtures of C4 grasses and legumes described herein, the above-ground biomass can be harvested and supplied to a company for use, for example, as combustible energy (with or without one or more fossil fuels) or to a fuel-producing company for use in cellulosic ethanol or synthetic fuel production. In such cases, the fields planted with a mixture of at least one C4 grass and at least one legume are usually located within about 60 miles of the company so that transportation of the biomass to the company does not negate any of the net energy gain obtained from growing C4 grasses and legumes as described herein. Net energy gain can be defined as the biofuel energy produced per unit of fossil energy invested in the total lifecycle of biofuel production.

In accordance with the present invention, there may be employed conventional techniques, which are explained fully in the literature and/or routinely practiced in the relevant art. The invention will be further described in the following examples, which do not limit the scope of the invention described in the claims.

### EXAMPLES

### Example 1

### Background

The number of plant species was controlled in 152 plots, each 9 m×9 m, in a 7 ha field at Cedar Creek Natural History Area, Minnesota. Plots were randomly chosen for seeding with 1, 2, 4, 8 or 16 perennial grassland/savanna species. Compositions of each plot was randomly chosen from a set of 18 perennials: four C4 grasses, four C3 grasses, three herbaceous and one woody-shrubby legume, four non-legume herbaceous forbs, and two savanna oak species (Table 1).

TABLE 1
The 18 perennial native prairie species

| Species | Functional type |
|---|---|
| Lupinis perennis | Legume |
| Andropogon gerardi | C4 grass |
| Schizachyrium scoparium | C4 grass |
| Sorghastrum nutans | C4 grass |
| Solidago rigida | Forb |
| Amorpha canescens | Woody legume |
| Lespedeza capitata | Legume |
| Poa pratensis | C3 grass |
| Petalostemum purpureum | Legume |
| Monarda fistulosa | Form |
| Achillea millefolium | Form |
| Panicum virgatum | C4 grass |
| Liatris aspera | Forb |
| Quercus macrocarpa | Woody |
| Koeleria cristata | C3 grass |
| Quercus elipsoidalis | Woody |
| Elymus canadensis | C3 grass |
| Agropyron smithii | C3 grass |

Plots received 10 g m⁻² of seed the first year and 5 g m⁻³ the second year, with seed mass divided equally among species. Treatments were maintained by weeding 3 or 4 times annually, with low-diversity treatments having much more weedy biomass removed than high-diversity treatments. Plots received low inputs (i.e., no fertilization, irrigation only during initial establishment, and herbicide only to prepare area for initial planting). Plots were burned annually in spring before growth began.

Plots were sampled annually in early August of each year for above-ground living plant biomass by clipping, drying, and weighing four parallel and evenly spaced 0.1×3.0 m or 0.1×6.0 m vegetation strips per plot. Different locations were clipped each year. For all 152 plots, including the LIHD plots, burning effectively removed all above-ground biomass. However, because fire did not carry through other plots that had been planted to be woody monocultures nor through low-diversity woody-dominated plots, those plots were excluded from this experiment. In contrast, annual burning removed above-ground woody biomass, and essentially removed woody species from multi-species plots, making above-ground biomass a good measure of annual production of these herbaceous plots.

Organic carbon was measured in the soil in 50 plots that were a randomly chosen subset of 1-, 4-, and 16-species plots. Soils were sampled at 3 depths (0-20 cm; 20-40 cm; 40-60 cm) for each of four sites per plot both before plots were planted and periodically thereafter. Soils were sieved to remove roots. Soil sequestration or release of carbon was determined as the change (ΔC) at each soil depth in the soil organic carbon. These ΔC values were then summed over the three soil depths and divided by the lapsed time to give the annual net rate of carbon storage or release.

Root mass was sampled in all 152 plots using twelve soil cores per plot (5 cm diameter by 30 cm deep), collected in mid-August just after biomass sampling. Soil cores were placed on a fine mesh screen and a gentle spray of water was used to rinse soil from roots. Roots were dried, any residual soil on dried samples was removed, then roots were weighed to obtain root mass per area. An additional subset of 10 plots planted to 16 species was sampled for roots from 0-30 cm depth, 30-60 cm depth, and 60-100 cm depth to estimate root mass below 30 cm in high diversity plots.

### Example 2

### Experimental Protocols

Data were analyzed from a large biodiversity experiment where the number of herbaceous perennial grassland species was controlled in 152 plots (see, for example, Tilman et al., 2006(a)), each 9 m×9 m at Cedar Creek Natural History Area, Minnesota. Plots were established in 1994 and seeded to contain 1, 2, 4, 8 or 16 grassland savanna species. The composition of each plot was randomly chosen from a pool of 18 species, which included four C4 grasses, four C3 grasses, four legumes, four non-legume herbaceous forbs and two woody-savanna species (Quercus spp.). There were 28 to 35 replicates at each level of species diversity. The 152 plots neither included woody monocultures nor low-diversity plots (2 and 4-species plots) with woody seedlings represented (see, for example, Tilman et al., 2006(a)). Plot compositions were maintained by manually weeding (3 or 4 times annually) and plots were burned each year in spring before growth began. Soil carbon and nitrogen samples were collected in 1994 and 2006 at 0-20, 20-40, 40-60 and 60-100 cm soil depth increments for each of nine sites per plot.

Samples from each plot were sieved to remove roots, combined by depth for each plot, mixed and ground. Two soil samples for each depth increment per plot were analyzed for total organic carbon and nitrogen by combustion and gas chromatography (COSTECH Analytical ECS 4010 instrument). The average of the two measurements of carbon and nitrogen was used in all statistical analyses. Net soil carbon and nitrogen sequestration at each soil depth level was calculated as the difference in soil carbon and nitrogen concentration measured between 2006 and 1994. Plots were also sampled for above- and below-ground biomass in the fall of 2006. Above-ground plant biomass, which is a measure of net primary productivity (NPP), was collected by clipping, drying and weighing four parallel and evenly spaced 0.1 m×3.0 m vegetation strips per plot in 1998, and four 0.1 m×6.0 m strips in 2000, 2004 and 2006. Plots were sampled for below-ground biomass in the fall of 2006 by collecting three evenly spaced soil cores in each of the four clipped strips. Each core was 5 cm in diameter and was divided into three soil depths (0-30, 30-60 and 60-100 cm deep). Soil cores were washed with a gentle spray of water over a fine mesh screen until roots were free of soil. Roots were then dried; any soil residual was removed and then roots were weighed. Plant tissue nitrogen (%) was measured in both above- and below-ground plant material.

Root production was measured in 60 plots (20 randomly chosen plots for each of the 1, 4 and 16 species treatments) during 2006 using in-growth soil cores. Roots were removed from a soil volume of 251.2 cm³ which was collected at three different soil depths (0-20, 20-40 and 40-60 cm deep) in two sites per plot by using a metallic cylinder corer. Soil cores were extracted beginning in the fall and roots were sieved and removed from the soil samples. A hardware mesh wire (1 cm diameter) was shaped to fit into the hole until reaching a soil depth of 30 cm, then the root-free soil was returned to the hole from which was collected. After two months, soil samples were extracted in the same place by coring within the mesh wire. New grown roots were sieved, dried and weighed by using a four-digit lab scale.

### Example 3

### Statistical Analysis

Univariate regressions were used to determine the effects of plant species number on net soil carbon and nitrogen sequestration (i.e. net soil carbon and nitrogen accumulation) 12 years after the grassland biodiversity experiment was established. Univariate regressions also were used to address the relationship between above- and below-ground biomass and the effects of species number on total above- and below-ground plant biomass and root production. Multiple regressions were performed including backward/forward stepwise regression analyses to test for the effects of species number, soil depth level and functional composition on different ecosystem response variables. Functional composition was expressed by variables, describing each functional group (C4, C3, forbs and legumes) as either absent from a plot or represented by at least one species. Multiple regression analyses including stepwise backward/forward regressions were performed using different predictor variables such as total below- and above-ground biomass, plant nitrogen tissue, plant carbon:nitrogen ratio, number and composition of plant species, and number of functional groups in different combinations on net rates of soil carbon and nitrogen storage.

### Example 4

### Plant Diversity and Composition Effects on Soil Carbon and Nitrogen Sequestration

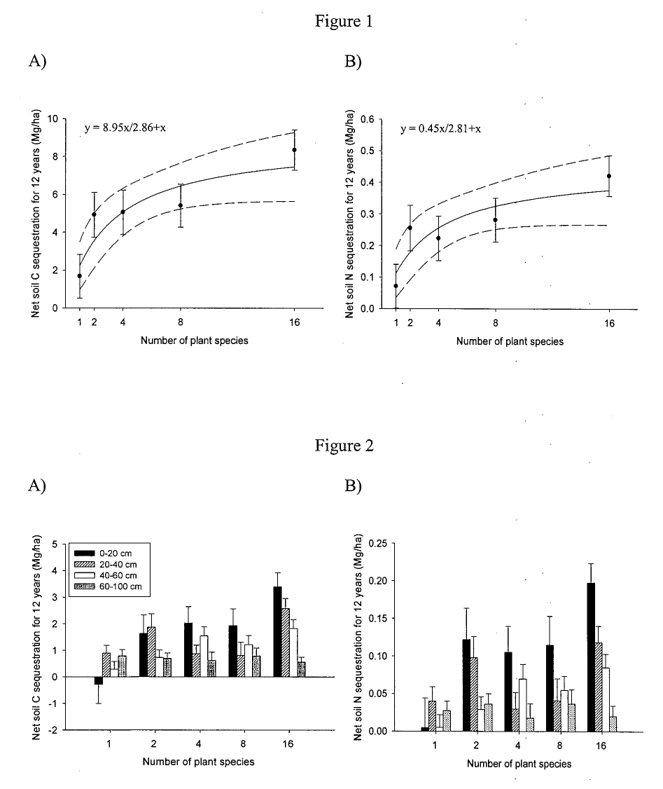

Net soil carbon accumulation (R²=0.10; F_{1,152}=15.5, P=0.0001) to 1 m soil depth as measured in 2006 (12 years after the grassland experiment was established) was a significantly increasing function of plant species number (FIG. 1A). The 16-species diversity plots accumulated on average 8.34±1.04 Mg ha⁻¹ (mean±SE) of total carbon in the soil (70±8 g m⁻² y⁻¹), whereas significant soil carbon sequestration in the monoculture plots was not found, 1.67±1.14 Mg ha⁻¹ of total soil carbon (10±9 g m⁻² y⁻¹). Moreover, net soil nitrogen accumulation to 1 m soil depth from 1994 to 2006 was significantly positively dependent on plant species number (R^{2=0.08}; F_{1,152}=9.6, P=0.0014; FIG. 1B).

The diversity effect on soil carbon and nitrogen storage from 1994 to 2006 seems to be partly related to higher diversity plant assemblages storing more carbon and nitrogen in deeper soils. A significant effect of soil depth (F_{3,607}=5.5, P=0.0009) was found, and a significant species diversity-soil depth interaction (F_{3,607}=4.02, P=0.007) on net soil carbon sequestration (FIG. 2A). The 16-species plots gained more carbon than lower-diversity plots at 0-20 (F_{1,152}=12.9, P=0.0004), 20-40 (F_{1,152}=7.2, P=0.008) and 40-60 cm soil depth levels (F_{1,152}=9.8, P=0.002), but not for the 60-100 cm depth (F_{1,152}=0.18, P=0.944). Similarly, net soil nitrogen storage was affected by soil depth (F_{3,607}=10.1, P<0.0001) and by a diversity-soil depth interaction (F_{3,607}=2.9, P 0.03; FIG. 2B). Higher diversity plots gained more nitrogen than lower diversity plots at 0-20 cm (F_{1,152}=10.8, P=0.0012), 20-40 cm (F_{1,152}=4.15, P=0.04) and 40-60 cm soil depth levels (F_{1,152}=9.4, P=0.0025), but not for the 60-100 cm depth (F_{1,152}=0.16, P=0.69).

How plant functional composition and diversity affected net rates of soil carbon and nitrogen storage from 1994 to 2006 was next addressed. It was found that the number of functional groups in each plot had positive effects on net soil carbon storage (R²=0.09; F_{4,151}=3.55, P=0.0084) and net soil nitrogen accumulation (R²=0.06; F_{4,151}=2.4, P=0.04) from 1994 to 2006.

Second, multiple regression analyses was performed using, as predictor variables, the presence or absence of legumes, C4 grasses, C3 grasses and forbs. These analyses showed that the presence of legumes and C4 grasses had significant positive effects on net soil carbon sequestration over 12 years (Table 2). It was also found that the presence of C4 grasses and legumes had significant positive effects on net rates of soil carbon change (g carbon y⁻¹) across the 12 year study (overall F_{4,152}=7.33, P<0.0001). The presence of C4 grasses and legumes (but not C3 grasses and forbs) was associated with significantly increased soil carbon and nitrogen storage to 60 cm soil depth (P<0.05 for all analyses). Net soil nitrogen accumulation was positively affected only by the presence of legume species (Table 2).

TABLE 2
Dependence of different ecosystem variables

| | Regression parameters for presence of each functional group | | | | | | |
|---|---|---|---|---|---|---|---|
| Response | | | | | | Overall | Overall F |
| variable | Intercept | Legume | C3 | C4 | Forb | r² | value |
| Net soil carbon | 374**** | 2.73**** | −0.21NS | 1.3** | −0.71NS | 0.18 | 8.2**** |
| sequestration | (Mg ha⁻¹) | | | | | | |
| Net soil nitrogen | 0.19**** | 0.13**** | −0.01NS | 0.05NS | −0.02NS | 0.12 | 5.03*** |
| sequestration | (Mg ha⁻¹) | | | | | | |
| Root biomass | 827**** (g | 229**** | 93.5** | 234**** | 30NS | 0.52 | 39**** |
| | m⁻²) | | | | | | |
| Root production | 182**** (g | 91*** | −1.85NS | 41NS | 25NS | 0.32 | 5.9**** |
| | m⁻²) | | | | | | |
| Root carbon: | 36.1**** | −6.8**** | −0.12NS | 4.8**** | 0.14NS | 0.48 | 34.8**** |
| nitrogen | (C:N, g:g) | | | | | | |
| Above-ground | 134.4**** | 59.1**** | 2.06NS | 17.3** | 24**** | 0.54 | 42.4**** |
| biomass | (g m⁻²) | | | | | | |

*P < 0.05;
**P < 0.01;
***P < 0.001;
****P < 0.0001

In a multiple regression with both plant species number and the presence/absence of legumes and C4 grasses as predictor variables, only species number (Estimate=0.40, t-ratio=2.49, P=0.014) and the presence of legumes (Estimate=1.95, t-ratio=3.11, P=0.0023) had significant effects (both positive) on net rates of soil C accumulation. Similarly, of these five variables, only plant species number and legume presence significantly increased soil N accumulation between 1994 and 2006 (P<0.02 for both variables).

### Example 5

### Quantitative Effects of Plant Diversity on Soil Carbon and Nitrogen Sequestration

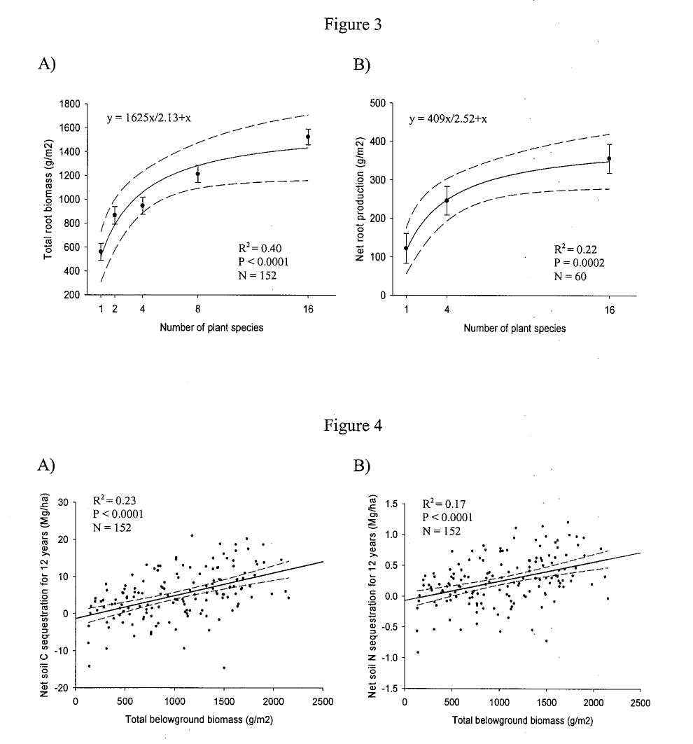

Plant diversity had significant positive effects on 2006 total root biomass, which is the root mass that had accumulated from the time of planting, 1994, to 2006 (R^{2=0.40}; F_{1,152}=99.1, P<0.0001; FIG. 3A) and on total root production as measured in 2006 (R²=0.22; F_{1,58}=15.9, P=0.0002; FIG. 3B). The 16-species plots produced on average 349.6±38.2 g/m² of roots over the two months period, whereas root production averaged 245.7±42.4 g/m² in the 4 species treatment plots and 121.5±27.5 g/m² in the monocultures.

There was a significant effect of soil depth on total root biomass accumulated between 1994 and 2006 (R²=0.63; F_{2,455}=384, P<0.0001), with increasing root biomass being accumulated in the 0-30 cm soil depth level. A significant plant diversity-soil depth interaction also was found (R²=0.12; F_{8,455}=7.3, P<0.0001) with a strong positive effect of the 16-species plots on root biomass accumulation in the 0-30 cm soil depth level.

Net soil carbon and nitrogen accumulation from 1994 to 2006 were significantly dependent on total root biomass (see FIG. 4A, B). In a multiple regression with both plant species number and total root biomass as predictor variables, root biomass had a positive significant effect on net rates of soil carbon storage (estimate=0.006, t-ratio=5.18, P<0.0001) and plant diversity was no longer significant (estimate=0.001, t-ratio=0.02, P=0.98). This suggests that high plant diversity may contribute to enhanced net soil carbon sequestration by increasing total root biomass accumulation (i.e. increasing soil carbon and nitrogen inputs; see FIG. 3A, B). Moreover, a multiple regression comparing the effects of total root biomass accumulation and total root production, both measured on net soil carbon and nitrogen sequestration (n=60), showed that only the former significantly affected net soil carbon (estimate=0.007, t-ratio=3.02, P=0.0039) and net soil nitrogen sequestration (estimate=0.0003, t-ratio=2.46, P=0.0174), whereas root production neither significantly affected soil carbon sequestration (estimate=0.005, t-ratio=1.22, P=0.22) nor soil nitrogen sequestration (estimate=0.0002, t-ratio=0.94, P=0.35). It also was found that plant diversity was positively related with total above-ground biomass (R²=0.46; F_{1,152}=125.6, P<0.0001) and that total below-ground and above-ground plant biomass were highly correlated (R²=0.51, F_{1,152}=156, P<0.0001). Consistent with this, net soil carbon and nitrogen accumulation after 12 years were both strongly positively dependent on total above-ground biomass (P<0.0001 for both analyses) as well as on total plant biomass (the sum of above-ground and below-ground biomass; (P<0.0001 for both analyses).

### Example 6

### Quantitative Effects of Plant Composition on Soil Carbon and Nitrogen Sequestration

Positive effects of functional diversity (i.e. the number of plant functional groups present in each plot) were found on total root biomass as well as on root biomass at each of the first two soil depths (0-30 cm and 30-60 cm; P<0.0001 for all analyses) but not between 60-100 cm soil depth. Multiple regressions addressing the effects of the number of C4 grass, C3 grass, legume and forb species in each plot as predictor variables on root biomass (0-100 cm depth) showed that total root mass was significantly increased by the number of legume species (P<0.0001), the number of C4 grass species (P<0.0001) and by their interaction (P=0.0011), but was not dependent on the number of C3 grass species (P>0.19), whereas the number of forb species had a significant negative effect on total root mass accumulation (P<0.013). In additional regressions, both the number of C4 grass species and the number of legume species significantly increased root biomass for 0-30 cm soil depths, whereas the number of legume species (P<0.0001) but not of C4 grass species (P=0.29) significantly increased root biomass for 30-60 cm soil depths. For both analyses, the interaction between C4 grasses and legumes was also significant (P=0.0002 for the 0-30 cm soil depth increment and P=0.042 for the 30-60 cm soil depth increment).

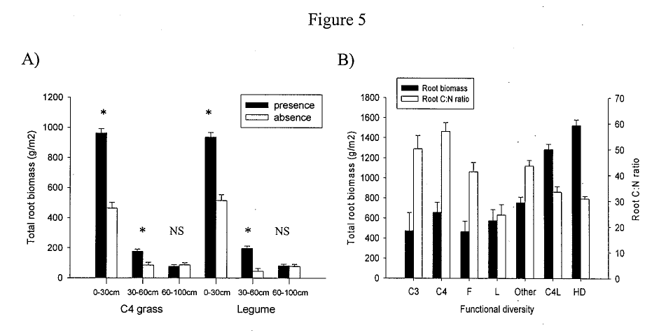

Plant functional group composition also impacted total root biomass, which, as has already been shown, is significantly correlated with soil carbon and nitrogen storage. Specifically, the presence of C4 grasses, C3 grasses and legumes increased total root biomass (Table 2), whereas root production was only affected by the presence of legume species (Table 2). A significant C4 grass×legume interaction (P=0.0023) on total root biomass was also found in 2006 but not a C3 grass×legume interaction (P=0.831). The presence of C4 grasses, C3 grasses and legumes significantly increased the 2006 root biomass between 0-30 cm soil depth (P<0.002 for all analyses). Moreover, C4 grasses and legumes significantly increased root biomass between 30-60 cm soil depth but C3 grasses did not (P=0.70). C4 grass×legume interactions did significantly increase root biomass between 0-30 and 30-60 cm soil depth (P<0.03 for both analyses) whereas C3 grass×legume interactions were not significant (P>0.154 for both analyses). Finally, neither C4 grasses nor legumes significantly affected root biomass between 60-100 cm soil depth (P>0.54 for all analyses; FIG. 5A).

The complementarity between the C4 grasses and the legumes on total root biomass is shown in FIG. 5B, where the presence of at least one C4 grass and one legume species within the 2, 4 and 8 species plots significantly increased total root biomass relative to monocultures and to all other combinations of functional groups (P<0.0001 for all analyses). However, having higher numbers of C4 grasses and legumes, as in the 16-species plots (“high diversity” plots in FIG. 5B), significantly contributed to greater 2006 root biomass than for those 2, 4 and 8 species plots which included on average a lower number of C4 grass and legume species (the “C4L” plots of FIG. 5B; P=0.003). The presence of C4 grasses, forbs and legumes was each found to contribute to greater total above-ground biomass (Table 2).

As shown in Table 2, the presence of C4 grasses led to significantly greater root carbon:nitrogen ratios and the presence of legumes led to significantly lower carbon:nitrogen ratios. The root carbon:nitrogen ratio had a significant negative effect on soil carbon accumulation after 12 years (estimate=−0.11, t-ratio=−2.89, P=0.0045) as well as on soil nitrogen accumulation (estimate=−0.006, t-ratio=−2.78, P=0.0061). Moreover, root carbon:nitrogen ratio had a negative significant effect on total root biomass measured in 2006 (P<0.003). This means that soil carbon and nitrogen accrual as well as root biomass increased more through time in those plots with lower root carbon:nitrogen ratios. A multiple regression of the joint effects of root carbon:nitrogen ratio and total root biomass on soil carbon and nitrogen accumulation showed that both carbon and nitrogen accrual were significantly greater at higher total root biomass (P<0.00001 for both analyses) and that root carbon:nitrogen ratio was not significant in either analysis (P>0.084 for all analyses). This suggests that the effect of root carbon:nitrogen ratio on soil carbon and nitrogen accumulation may result more from the effects of root carbon:nitrogen on root biomass than on some direct effect of root carbon:nitrogen on its carbon and nitrogen accumulation. Specifically, it seems that intermediate root carbon:nitrogen ratios, resulting from the complementarity effect (C4 grasses and legumes), contributed to enhanced root mass accumulation which, in turn, increased soil carbon and nitrogen sequestration. In FIG. 5B, it was shown that the presence of at least one C4 grass and one legume species within the 2, 4 and 8 species plots and within the high diversity plots (the “HD” plots of FIG. 5B) had intermediate root carbon:nitrogen ratios, which were significantly different from monocultures plots or from all other combinations of functional groups (the “Other” of FIG. 5B; P<0.001 for all analyses).

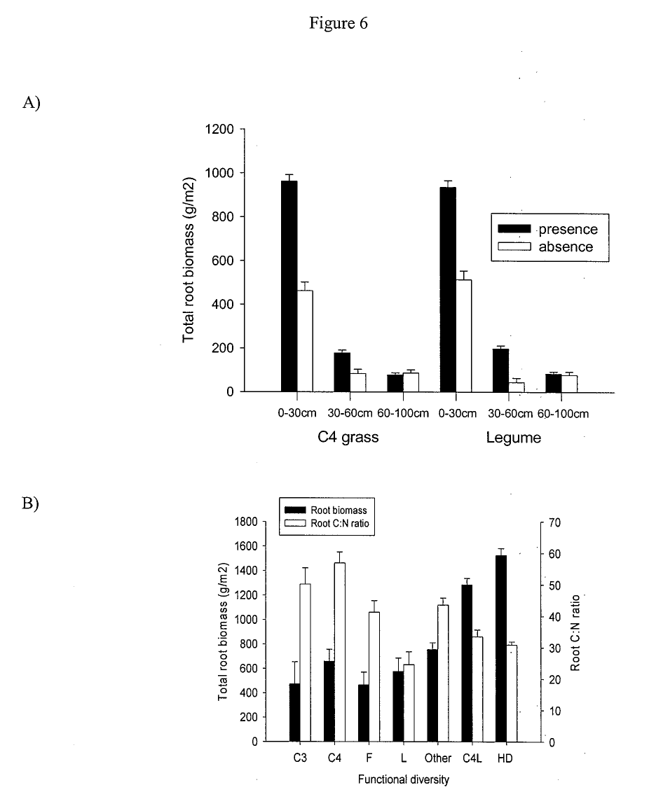

The graphs in FIG. 6 show that the presence of C4 grasses and legumes increased soil C sequestration by 193% and 522% respectively. A multiple regression analysis using as predictor variables the presence/absence of forbs, C3 grasses, C4 grasses and legumes shows that only the presence of legumes (estimate=2.73, P<0.0001) and C4 grasses (estimate=1.3, P=0.01) had positive significant effects on net soil carbon sequestration over the 12 year period examined. Legumes and C4 grasses had both significant positive effects on total root biomass (P<0.00001). Moreover the presence of these two functional groups significantly contributed to increase root biomass to 60 cm soil depth (FIG. 6). The combination of legumes and C4 grasses contributed to increase root biomass more than their monocultures or any functional combinations from where legumes and C4 grasses were absent (FIG. 6). Finally, it seems that intermediate root carbon:nitrogen ratios, resulting from the complementarity effect (C4 grasses and legumes; FIG. 6), contributed to enhance root mass accumulation which in turn increased soil carbon and nitrogen sequestration.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A method of monitoring a field that consists essentially of a mixture of at least one C4 grass and at least one legume, wherein the method comprises monitoring the field for carbon levels in the soil and/or carbon levels in the root biomass.

2. A method of maintaining a field that consists essentially of a mixture of at least one C4 grass and at least one legume, wherein the method comprises monitoring the field for carbon levels in the soil and/or carbon levels in the root biomass; and adjusting the number of C4 grasses and/or legumes, if necessary.

3. The method of claim 2, wherein the number of C4 grasses and/or legumes is adjusted if the carbon levels in the soil and/or the root biomass fail to increase at the desired rate.

4. The method of claim 2, wherein the number of C4 grasses and/or legumes is adjusted if the nitrogen levels in the soil decrease or fail to increase at the desired rate, if the amount of biomass decreases, and/or if the number of legumes decreases to less than 5% (w/w) or increases to more than 50% (w/w) of the total biomass of legumes and C4 grasses in the field.

5. The method of claim 1, further comprising monitoring the field for nitrogen levels in the soil, below-ground biomass, above-ground biomass, and/or the number of legumes relative to the total number of legumes and C4 grasses in the field.

6. A method of applying for one or more carbon credits, the method comprising:
growing, in a field, for at least two years, a mixture consisting essentially of at least one C4 grass and at least one legume;
obtaining certification for a reduction of CO₂ emissions and/or for an amount of carbon sequestered in plant biomass and/or in soil; and
applying for one or more carbon credits based on the certification obtained.

7. The method of claim 6, further comprising harvesting the above-ground biomass.

8. The method of claim 7, wherein the above-ground biomass is the C4 grasses.

9. The method of claim 6, further comprising adjusting the number of legumes relative to the total number and/or biomass of legumes and C4 grasses in the field.

10. The method of claim 6, further comprising measuring the amount of carbon in the soil or in the plant biomass.

11. A method of offsetting the carbon footprint of a fuel- or power-producing company, comprising:
identifying a fuel- or power-producing company in need of carbon offsetting;
planting sufficient acreage with a mixture consisting essentially of about 50% to about 95% C4 grasses and about 5% to about 50% legumes, wherein said acreage is sufficient to offset, at least partially, the carbon footprint of said fuel- or power-producing company.

12. The method of claim 11, wherein the fuel- or power-producing company produces ethanol or another biofuel, or electricity.

13. The method of claim 11, wherein the above-ground biomass from said field is harvested to supply biofuel feedstock or to provide power to the fuel- or power-producing company.

14. The method of claim 13, wherein said acreage is within 60 miles of the fuel-producing company.

15. The method of claim 11, wherein said acreage is monitored for carbon levels in the soil and/or carbon levels in the root biomass.

16. The method of claim 11, further comprising applying for carbon credits.

17. A method of sequestering carbon, comprising growing, for at least two years, a mixture consisting essentially of about 20% to about 80% (w/w) of at least one C4 grass and about 20% to about 80% (w/w) of at least one legume in a field.

18. The method of claim 17, wherein carbon is sequestered in the root biomass and/or in the soil.

19. The method of claim 17, further comprising obtaining certification for one or more carbon credits based on the carbon sequestered.
